(19) United States
(12) Patent Application Publication
(10) Pub. No.: US 2021/0295750 A1
(43) Pub. Date: Sep. 23, 2021

(54) SPECIAL-SHAPED DISPLAY PANEL AND DISPLAY DEVICE CAPABLE OF IMPROVING MURA EFFECT

(71) Applicant: Wuhan China Star Optoelectronics Technology Co.Ltd., Wuhan (CN)

(72) Inventors: Zhou ZHANG, Wuhan (CN); Yucheng TSAI, Wuhan (CN); Changwen MA, Wuhan (CN); Pan XU, Wuhan (CN)

(73) Assignee: Wuhan China Star Optoelectronics Technology Co.Ltd., Wuhan (CN)

(21) Appl. No.: 16/625,761

(22) PCT Filed: Sep. 12, 2018
(86) PCT No.: PCT/CN2018/105177

§ 371 Date: Dec. 23, 2019

(30) Foreign Application Priority Data
Jul. 26, 2018 (CN) 201810830985.9

(51) Int. Cl. G09F 9/302; G09G 3/20

(52) U.S. Cl. CPC G09F 9/302; G09G 3/2092; G09G 2300/0426; G09G 2320/0626; G09G 2320/0233

(57) ABSTRACT

A special-shaped display panel and a display device are provided. The special-shaped display panel includes a display region provided for displaying images, the display region having a notch after special-shaped cutting; and a non-display region including a peripheral layout region and a notch region corresponding to the notch of the display region, wherein the display region is divided into a plurality of common electrode regions according to extension of at least one edge of the notch region, at least two of the plural common electrode regions have different common voltage configurations. Mura effect and display quality are improved.

### FIELD OF THE DISCLOSURE

The present application relates to display technologies, and more particularly, to a special-shaped display panel and a display device capable of improving mura effect

### DESCRIPTION OF RELATED ARTS

With development of smartphones and tablets, a screen-to-body ratio is increasing, further toward a trend of full display. The display screen is developed from having a rectangular display region to having a rectangular display region with a notch. The display panel having such a display region is called a special-shaped display panel.

FIG. 1 is a schematic diagram illustrating a regular rectangular display panel 10. As shown in FIG. 1, the display panel 10 includes a rectangular display region 11 and a non-display region 12. The non-display region 12 includes a peripheral layout region 121 and a chip 122.

In the display region 11, each of source data lines is connected to a same number of thin-film transistors (TFTs). For example, in a display region with a resolution 1080*2160, the number of TFTs connected to each source data line is 2160. Further, common electrodes (Vcom electrodes) in whole display region 11 are all connected to the chip 122 via the peripheral layout region 121. The chip 122 provides a same common voltage to all of the common electrodes in the display region 11.

### Technical Problems

FIG. 2 is a schematic diagram illustrating an existing special-shaped display panel 20. As shown in FIG. 2, a display region 21 of the special-shaped display panel 20 has a notch 25. In the existing special-shaped display panel 20, the number of TFTs connected to a source data line in the display region at left and right sides of a position corresponding to the notch 25 is much larger than the number of TFTs connected to a source data line in the display region corresponding to the notch 25. This makes that the loading of the source data lines at the left and right sides is heavier than the loading of the source data lines corresponding to the notch 25. This results in a high possibility of mura effect with uneven brightness appeared near the notch 25. For example, bright lines or dark lines appear at the border of the notch 25, as indicated by dotted lines in FIG. 2.

Therefore, there is a need to improve the drawbacks in the existing arts.

### Technical Solutions

The objective of the present application is to provide a special-shaped display panel and a display device for improving display quality.

To achieve above objective, an aspect of the present application provides a special-shaped display panel, including: a display region provided for displaying images, the display region having a notch after special-shaped cutting; and

a non-display region including a peripheral layout region and a notch region corresponding to the notch of the display region, wherein the display region is divided into a plurality of common electrode regions according to extension of at least one edge of the notch region, at least two of the plural common electrode regions have different common voltages, the common electrode regions of the plural common electrode regions that are identical in size have a same common voltage, the common electrode regions of the plural common electrode regions that are different in size have different common voltages; and wherein the notch region of the non-display region includes a rectangular region, the rectangular region has a first edge, a second edge opposite to the first edge, and a third edge and a fourth edge that are located at two sides of the first edge and the second edge and perpendicular to the first edge and the second edge, the third edge is opposite to the fourth edge.

Another aspect of the present application provides a special-shaped display panel, including: a display region provided for displaying images, the display region having a notch after special-shaped cutting; and a non-display region including a peripheral layout region and a notch region corresponding to the notch of the display region, wherein the display region is divided into a plurality of common electrode regions according to extension of at least one edge of the notch region, at least two of the plural common electrode regions have different common voltage configurations.

Still another aspect of the present application provides a display device, including a special-shaped display panel, the special-shaped display panel including: a display region provided for displaying images, the display region having a notch after special-shaped cutting; and a non-display region including a peripheral layout region and a notch region corresponding to the notch of the display region, wherein the display region is divided into a plurality of common electrode regions according to extension of at least one edge of the notch region, at least two of the plural common electrode regions have different common voltage configurations.

In an embodiment of the present application, at least two of the plural common electrode regions have different common voltages.

In an embodiment of the present application, the common electrode regions of the plural common electrode regions that have different size have different common voltages.

In an embodiment of the present application, the common electrode regions of the plural common electrode regions that have a same size have a same common voltage.

In an embodiment of the present application, the notch region of the non-display region includes a rectangular region, the rectangular region has a first edge, a second edge opposite to the first edge, and a third edge and a fourth edge that are located at two sides of the first edge and the second edge and perpendicular to the first edge and the second edge, the third edge is opposite to the fourth edge.

In an embodiment of the present application, according to extension of the first edge of the rectangular region, the display region is divided into a first common electrode region and a second common electrode region at a side of the extension of the first edge and a third common electrode region at the other side of the extension of the first edge, the first common electrode region and the second common electrode region have a same common voltage, the third common electrode region has a common voltage different from the common voltages of the first common electrode region and the second common electrode region.

In an embodiment of the present application, according to extension of the third edge and the fourth edge of the rectangular region, the display region is divided into a first common electrode region and a second common electrode region at two sides of the notch region and a third common electrode region at a position corresponding to the notch region, the first common electrode region and the second common electrode region have a same common voltage, the third common electrode region has a common voltage different from the common voltages of the first common electrode region and the second common electrode region.

In an embodiment of the present application, according to extension of the first edge, the third edge, and the fourth edge of the rectangular region, the display region is divided into a first common electrode region, a second common electrode region, a third common electrode region, a fourth common electrode region, and a fifth common electrode region, the first common electrode region and the fifth common electrode region are identical in size, the second common electrode region and the fourth common electrode region are identical in size, the third common electrode region is different from the first common electrode region and the second common electrode region in size, the common electrode regions having a same size have a same common voltage, the common electrode regions having different size have different common voltages.

### Beneficial Effects

In the present application, the display region is divided into a plurality of common electrode regions according to extension of at least one edge of the notch region. At least two of these common electrode regions have different common voltage configurations. Accordingly, the common voltages may be provided based on the number of TFTs connected to a source data line. In such a way, mura effect in which bright lines or dark lines appear near the notch in the existing arts is improved as well as display quality.

### DESCRIPTION OF DRAWINGS

To make above content of the present invention more easily understood, it will be described in details by using preferred embodiments in conjunction with the appending drawings.

FIG. 1 is a schematic diagram illustrating a regular rectangular display panel.

FIG. 2 is a schematic diagram illustrating an existing special-shaped display panel.

FIG. 3 is a schematic diagram illustrating a special-shaped display panel according to the present application.

FIG. 4 is a schematic diagram illustrating another special-shaped display panel according to the present application.

FIG. 5 is a schematic diagram illustrating still another special-shaped display panel according to the present application.

FIG. 6 is a schematic diagram illustrating a display device according to the present application.

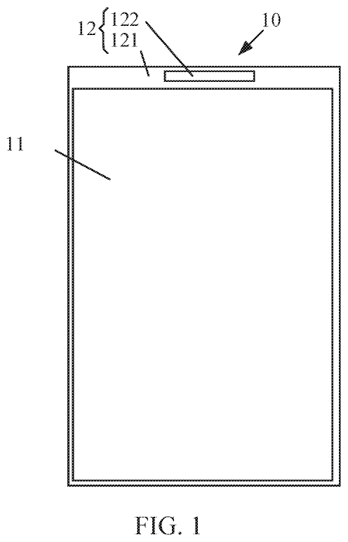

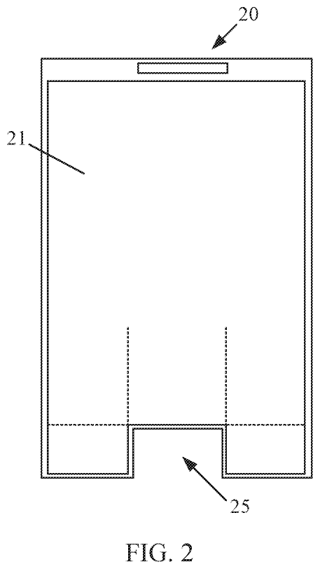

### DESCRIPTION OF EMBODIMENTS OF THE DISCLOSURE

To make the objectives, technical schemes, and effects of the present application more clear and specific, the present application is described in further detail below with reference to the embodiments in accompanying with the appending drawings. It should be understood that the specific embodiments described herein are merely for explaining the present application, the term “embodiment” used in the context means an example, instance, or illustration, and the present application is not limited thereto.

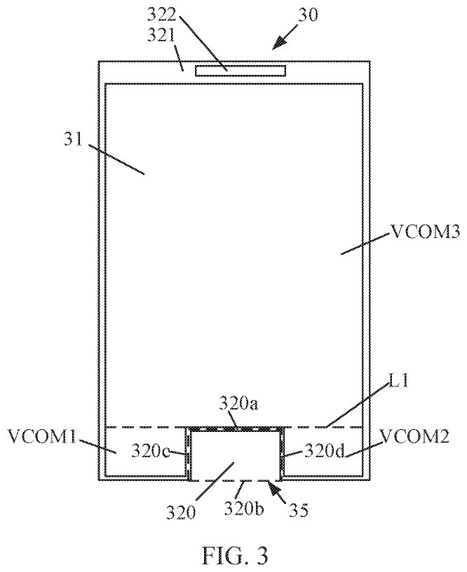

FIG. 3 is a schematic diagram illustrating a special-shaped display panel 30 according to the present application. The special-shaped display panel 30 may integrate various types of technologies, for example, externally applied touch sensors, touch sensors deployed in a thin-film transistor (TFT) substrate (TP in cell), touch sensors deployed on the TFT substrate (TP on cell), and so on. The special-shaped display panel 30 includes a display region (or called an active area, AA) 31 and a non-display region located outside of the display region 31.

The display region 31 includes a plurality of scan lines (not shown) and a plurality of data lines (not shown). The scan lines are used to provide scan signals and the data lines are used to provide data signals. The display region 31 also includes a plurality of pixel units (not shown) formed by interlacing the scan lines and the data lines with one another.

The display region 31 of the special-shaped display panel 30 is provided for directly displaying images. The non-display region is provided for deploying other elements to assist the display region in displaying images. The non-display region is not provided for directly displaying images.

As shown in FIG. 3, the special-shaped display panel 30 has been performed with special-shaped cutting such that the display region 31 has a notch 35. The non-display region includes a notch region 320 corresponding to the notch 35 of the display region 31. It can be understood that the notch region 320 is a defined virtual region. There is no substance in this region.

The non-display region of the special-shaped display panel 30 further includes a peripheral layout region 321 and a chip 322. The chip 322 can provide common voltages (Vcom), which are provided to common electrodes (not shown) in the display region 31 via the peripheral layout region 321.

In the present application, as shown in FIG. 3, the display region 31 is divided into a plurality of common electrode regions VCOM1, VCOM2, VCOM3 according to extension (as indicated by the dashed line L1) of at least one edge of the notch region 320. At least two of the common electrode regions VCOM1, VCOM2, VCOM3 have different common voltage configurations. For example, VCOM1 and VCOM3 have different common voltage configurations and VCOM2 and VCOM3 have different common voltage configurations.

Specifically, the aforesaid common voltage configuration may be referred to the common voltages provided to the common electrode regions VCOM1, VCOM2, VCOM3 when (the chip 322 of) the special-shaped display panel 30 is activated to display images. That is to say, during the image displaying, the common voltages provided to two or more than two common electrode regions by the special-shaped display panel 31 can be different in the present application.

The aforesaid common voltage configuration may also be referred to a default configuration of common voltages outputted to the common electrode regions by the chip 322. The chip 322 may be a chip having an ability to adjust the common voltages. In this way, the chip 322 can provide appropriate common voltages for the common electrode regions. The chip 322 may have two or more than two functional elements for fine tuning the common voltage to provide different common voltages for two or more than two common electrode regions. Of course, more than one chip 322 may be deployed. The number of the chips 322 may be determined according to the number of types of the common voltages to be provided to the common electrode regions.

It is noted that a common electrode region mentioned in the context is referred to a region in which the common voltages provided (at some point during the image displaying) to all the common electrodes within the region by the special-shaped display panel 30 are identical to one another and the region has a distinguishable position. The common electrode region is a part of the display region 31.

In the present application, the display region 31 is divided into a plurality of common electrode regions according to extension of at least one edge of the notch region 320. At least two of these common electrode regions have different common voltage configurations. Accordingly, the common voltages may be provided based on the number of TFTs connected to a source data line. For example, in FIG. 3, the number of TFTs connected to a source data line in VCOM3 is apparently larger than the number of TFTs connected to a source data line in VCOM1 (or VCOM2). Different common voltages are provided to VCOM3 and VCOM1 (or VCOM2). In such a way, mura effect in which bright lines or dark lines appear near the notch 35 in the existing arts is improved as well as display quality.

In the present application, whether the common voltages to be provided to the common electrode regions are the same can be determined based on the size of the common electrode regions obtained by dividing the display region 31. Specifically, a same common voltage is provided to the common electrode regions that are identical in size and different common voltages are provided to the common electrode regions that are different in size.

For example, in FIG. 3, VCOM1 and VCOM2 are identical in size and the common voltages provided to these common electrode regions are the same; VCOM3 and VCOM1 are different in size and the common voltages provided to these common electrode regions are different; VCOM3 and VCOM2 are different in size and the common voltages provided to these common electrode regions are different.

Further, as shown in FIG. 3, the notch region 320 of the non-display region may include a rectangular region. The rectangular region has a first edge (e.g., a top edge) 320a, a second edge (e.g., a bottom edge) 320b opposite to the first edge 320a, and a third edge (e.g., a left edge) 320c and a fourth edge (e.g., a right edge) 320d that are located at two sides of the first edge 320a and the second edge 320b and perpendicular to the first edge 320a and the second edge 320b. The third edge 320c is opposite to the fourth edge 320d.

As illustrated in the embodiment of FIG. 3, according to extension (as indicated by the dashed line L1) of the first edge (e.g., the top edge) 320a of the rectangular region, the display region 31 is divided into a first common electrode region VCOM1 and a second common electrode region VCOM2 at a side of the extension of the first edge 320a and a third common electrode region VCOM3 at the other side of the extension of the first edge 320a.

As shown in FIG. 3, the first common electrode region VCOM1 and the second common electrode region VCOM2 are identical in size and their numbers of TFTs connected to a source data line are the same. Accordingly, a same common voltage is provided to the first common electrode region VCOM1 and the second common electrode region VCOM2. The size of the third common electrode region VCOM3 is different from the size of the first common electrode region VCOM1 and the size of the second common electrode region VCOM2. Their numbers of TFTs connected to a source data line are also different. Accordingly, the common voltage provided to the third common electrode region VCOM3 is different from the common voltages provided to the first common electrode region VCOM1 and the second common electrode region VCOM2. That is, the common voltages provided to the common electrode regions that are identical in size are the same and the common voltages provided to the common electrode regions that are different in size are different.

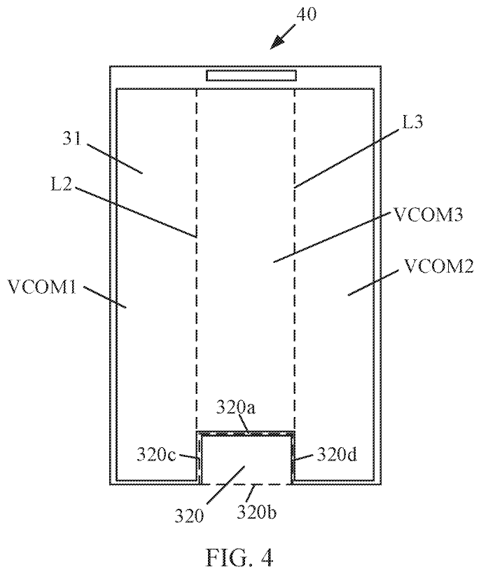

In another embodiment as illustrated in a special-shaped display panel 40 shown in FIG. 4, according to extension (as indicated by the dashed lines L2 and L3) of the third edge (e.g., the left edge) 320c and the fourth edge (e.g., the right edge) 320d of the rectangular region, the display region 31 is divided into a first common electrode region VCOM1 and a second common electrode region VCOM2 at two sides of the notch region 320 and a third common electrode region VCOM3 at a position corresponding to the notch region 320.

As shown in FIG. 4, the first common electrode region VCOM1 and the second common electrode region VCOM2 are identical in size and their numbers of TFTs connected to a source data line are the same. Accordingly, a same common voltage is provided to the first common electrode region VCOM1 and the second common electrode region VCOM2. The size of the third common electrode region VCOM3 is different from the size of the first common electrode region VCOM1 and the size of the second common electrode region VCOM2. Their numbers of TFTs connected to a source data line are also different. Accordingly, the common voltage provided to the third common electrode region VCOM3 is different from the common voltages provided to the first common electrode region VCOM1 and the second common electrode region VCOM2. That is, the common voltages provided to the common electrode regions that are identical in size are the same and the common voltages provided to the common electrode regions that are different in size are different.

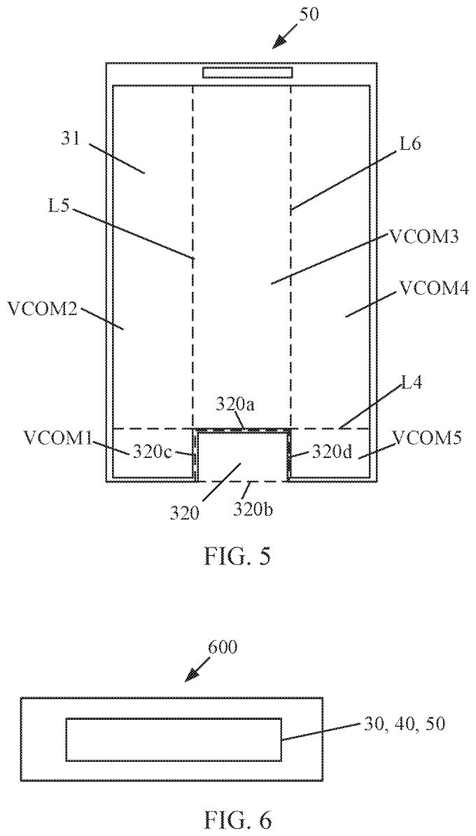

In still another embodiment as illustrated in a special-shaped display panel 50 shown in FIG. 5, according to extension (as indicated by the dashed lines L4, L5, and L6) of the first edge (e.g., the top edge), the third edge (e.g., the left edge), and the fourth edge (e.g., the right edge) of the rectangular region, the display region 31 is divided into a first common electrode region VCOM1, a second common electrode region VCOM2, a third common electrode region VCOM3, a fourth common electrode region VCOM4, and a fifth common electrode region VCOM5.

As shown in FIG. 5, the first common electrode region VCOM1 and the fifth common electrode region VCOM5 are identical in size and their numbers of TFTs connected to a source data line are the same. Accordingly, a same common voltage is provided to the first common electrode region VCOM1 and the fifth common electrode region VCOM5. The second common electrode region VCOM2 and the fourth common electrode region VCOM4 are identical in size and their numbers of TFTs connected to a source data line are the same. Accordingly, a same common voltage is provided to the second common electrode region VCOM2 and the fourth common electrode region VCOM4. The size of the third common electrode region VCOM3 is different from the size of the first common electrode region VCOM1 and the size of the second common electrode region VCOM2. Their numbers of TFTs connected to a source data line are also different. Accordingly, the common voltage provided to the third common electrode region VCOM3 is different from the common voltages provided to the first common electrode region VCOM1 and the second common electrode region VCOM2. That is, the common voltages provided to the common electrode regions that are identical in size are the same and the common voltages provided to the common electrode regions that are different in size are different.

As shown in FIG. 6, the present application further provides a display device 600 including the special-shaped display panel 30, 40, or 50. The structure of the special-shaped display panel is illustrated above, and is not repeated herein for brevity.

Above all, while the preferred embodiments of the present application have been illustrated and described in detail, it is intended that the present application should not be limited to the preferred embodiment. Various modifications and alterations which maintain the realm of the present application can be made by persons skilled in this art. The protective scope of the present application is subject to the scope as defined in the claims.

What is claimed is:

1. A special-shaped display panel, comprising:
a display region provided for displaying images, the display region having a notch after special-shaped cutting; and
a non-display region comprising a peripheral layout region and a notch region corresponding to the notch of the display region,
wherein the display region is divided into a plurality of common electrode regions according to extension of at least one edge of the notch region, at least two of the plural common electrode regions have different common voltages, the common electrode regions of the plural common electrode regions that are identical in size have a same common voltage, the common electrode regions of the plural common electrode regions that are different in size have different common voltages; and
wherein the notch region of the non-display region comprises a rectangular region, the rectangular region has a first edge, a second edge opposite to the first edge, and a third edge and a fourth edge that are located at two sides of the first edge and the second edge and perpendicular to the first edge and the second edge, the third edge is opposite to the fourth edge.

2. The special-shaped display panel according to claim 1, wherein according to extension of the first edge of the rectangular region, the display region is divided into a first common electrode region and a second common electrode region at a side of the extension of the first edge and a third common electrode region at the other side of the extension of the first edge, the first common electrode region and the second common electrode region have a same common voltage, the third common electrode region has a common voltage different from the common voltages of the first common electrode region and the second common electrode region.

3. The special-shaped display panel according to claim 1, wherein according to extension of the third edge and the fourth edge of the rectangular region, the display region is divided into a first common electrode region and a second common electrode region at two sides of the notch region and a third common electrode region at a position corresponding to the notch region, the first common electrode region and the second common electrode region have a same common voltage, the third common electrode region has a common voltage different from the common voltages of the first common electrode region and the second common electrode region.

4. The special-shaped display panel according to claim 1, wherein according to extension of the first edge, the third edge, and the fourth edge of the rectangular region, the display region is divided into a first common electrode region, a second common electrode region, a third common electrode region, a fourth common electrode region, and a fifth common electrode region, the first common electrode region and the fifth common electrode region are identical in size, the second common electrode region and the fourth common electrode region are identical in size, the third common electrode region is different from the first common electrode region and the second common electrode region in size, the common electrode regions having a same size have a same common voltage, the common electrode regions having different size have different common voltages.

5. A special-shaped display panel, comprising:
a display region provided for displaying images, the display region having a notch after special-shaped cutting; and
a non-display region comprising a peripheral layout region and a notch region corresponding to the notch of the display region,
wherein the display region is divided into a plurality of common electrode regions according to extension of at least one edge of the notch region, at least two of the plural common electrode regions have different common voltage configurations.

6. The special-shaped display panel according to claim 5, wherein at least two of the plural common electrode regions have different common voltages.

7. The special-shaped display panel according to claim 5, wherein the common electrode regions of the plural common electrode regions that have different size have different common voltages.

8. The special-shaped display panel according to claim 5, wherein the common electrode regions of the plural common electrode regions that have a same size have a same common voltage.

9. The special-shaped display panel according to claim 5, wherein the notch region of the non-display region comprises a rectangular region, the rectangular region has a first edge, a second edge opposite to the first edge, and a third edge and a fourth edge that are located at two sides of the first edge and the second edge and perpendicular to the first edge and the second edge, the third edge is opposite to the fourth edge.

10. The special-shaped display panel according to claim 9, wherein according to extension of the first edge of the rectangular region, the display region is divided into a first common electrode region and a second common electrode region at a side of the extension of the first edge and a third common electrode region at the other side of the extension of the first edge, the first common electrode region and the second common electrode region have a same common voltage, the third common electrode region has a common voltage different from the common voltages of the first common electrode region and the second common electrode region.

11. The special-shaped display panel according to claim 9, wherein according to extension of the third edge and the fourth edge of the rectangular region, the display region is divided into a first common electrode region and a second common electrode region at two sides of the notch region and a third common electrode region at a position corresponding to the notch region, the first common electrode region and the second common electrode region have a same common voltage, the third common electrode region has a common voltage different from the common voltages of the first common electrode region and the second common electrode region.

12. The special-shaped display panel according to claim 9, wherein according to extension of the first edge, the third edge, and the fourth edge of the rectangular region, the display region is divided into a first common electrode region, a second common electrode region, a third common electrode region, a fourth common electrode region, and a fifth common electrode region, the first common electrode region and the fifth common electrode region are identical in size, the second common electrode region and the fourth common electrode region are identical in size, the third common electrode region is different from the first common electrode region and the second common electrode region in size, the common electrode regions having a same size have a same common voltage, the common electrode regions having different size have different common voltages.

13. A display device, comprising a special-shaped display panel, the special-shaped display panel comprising:
a display region provided for displaying images, the display region having a notch after special-shaped cutting; and
a non-display region comprising a peripheral layout region and a notch region corresponding to the notch of the display region,
wherein the display region is divided into a plurality of common electrode regions according to extension of at least one edge of the notch region, at least two of the plural common electrode regions have different common voltage configurations.

14. The display device according to claim 13, wherein at least two of the plural common electrode regions have different common voltages.

15. The display device according to claim 13, wherein the common electrode regions of the plural common electrode regions that have different size have different common voltages.

16. The display device according to claim 13, wherein the common electrode regions of the plural common electrode regions that have a same size have a same common voltage.

17. The display device according to claim 13, wherein the notch region of the non-display region comprises a rectangular region, the rectangular region has a first edge, a second edge opposite to the first edge, and a third edge and a fourth edge that are located at two sides of the first edge and the second edge and perpendicular to the first edge and the second edge, the third edge is opposite to the fourth edge.

18. The display device according to claim 17, wherein according to extension of the first edge of the rectangular region, the display region is divided into a first common electrode region and a second common electrode region at a side of the extension of the first edge and a third common electrode region at the other side of the extension of the first edge, the first common electrode region and the second common electrode region have a same common voltage, the third common electrode region has a common voltage different from the common voltages of the first common electrode region and the second common electrode region.

19. The display device according to claim 17, wherein according to extension of the third edge and the fourth edge of the rectangular region, the display region is divided into a first common electrode region and a second common electrode region at two sides of the notch region and a third common electrode region at a position corresponding to the notch region, the first common electrode region and the second common electrode region have a same common voltage, the third common electrode region has a common voltage different from the common voltages of the first common electrode region and the second common electrode region.

20. The display device according to claim 17, wherein according to extension of the first edge, the third edge, and the fourth edge of the rectangular region, the display region is divided into a first common electrode region, a second common electrode region, a third common electrode region, a fourth common electrode region, and a fifth common electrode region, the first common electrode region and the fifth common electrode region are identical in size, the second common electrode region and the fourth common electrode region are identical in size, the third common electrode region is different from the first common electrode region and the second common electrode region in size, the common electrode regions having a same size have a same common voltage, the common electrode regions having different size have different common voltages.
